(19) United States
(12) Patent Application Publication
(10) Pub. No.: US 2025/0062468 A1
(43) Pub. Date: Feb. 20, 2025

(54) BATTERY PACK FOR VEHICLE

(71) Applicants: Hyundai Motor Company, Seoul (KR); Kia Corporation, Seoul (KR)

(72) Inventors: Gyung Hoon Shin, Seoul (KR); Jong Gyu Park, Hwaseong-si (KR)

(21) Appl. No.: 18/604,971

(22) Filed: Mar. 14, 2024

(30) Foreign Application Priority Data
Aug. 14, 2023 (KR) 10-2023-0106341

(51) Int. Cl. H01M 50/242; H01M 10/6552; H01M 50/249

(52) U.S. Cl. CPC H01M 50/242; H01M 10/6552; H01M 50/249; H01M 2220/20

(57) ABSTRACT

An embodiment battery pack for a vehicle includes a frontward wall and a rearward wall, lateral side walls connecting opposite ends of the frontward and rearward walls to define an accommodating space for accommodating battery modules, a longitudinal member having first and second ends supported on the frontward and rearward walls, respectively, while crossing the accommodating space, a transverse member having first and second ends supported on the lateral side walls, respectively, while intersecting the longitudinal member across the accommodating space, and a reinforcing bracket disposed at an intersection between the longitudinal member and the transverse member, the reinforcing bracket increasing a coupling rigidity between the longitudinal member and the transverse member so that the coupling rigidity with the reinforcing bracket is greater than the coupling rigidity of the same structure without any reinforcing bracket.

### CROSS-REFERENCE TO RELATED APPLICATIONS

This application claims the benefit of Korean Patent Application No. 10-2023-0106341, filed on Aug. 14, 2023, which application is hereby incorporated herein by reference.

### TECHNICAL FIELD

The disclosure relates to a structure of a battery pack mounted to a vehicle.

### BACKGROUND

An electric vehicle or the like includes an electric motor to generate a driving force for the vehicle and a battery pack to supply electric power to the electric motor.

The battery pack accommodates a plurality of battery modules, and a plurality of battery cells are overlapped to make up the battery module.

To increase the range of the vehicle, the battery pack needs to accommodate more battery modules or battery cells therein. Further, to ensure appropriate crash performance of the vehicle, a plurality of reinforcing members is required in the battery pack.

In other words, when the plurality of reinforcing members is provided in the battery pack to ensure the crash performance of the vehicle, it is disadvantageous to increase the range of the vehicle because the number of battery modules or battery cells accommodated in the battery pack is reduced. On the other hand, when the reinforcing members in the battery pack are decreased to accommodate more battery modules in the battery pack, it is disadvantageous to ensure the crash performance of the vehicle because the rigidity of the battery pack is lowered.

The matters described as the related art are merely intended to promote the understanding of the background of embodiments of the disclosure, but they should not be accepted as recognition of the prior art that has already been known to a person having ordinary knowledge in the art.

### SUMMARY

An embodiment of the disclosure provides a battery pack for a vehicle, in which the number of battery cells accommodated in the battery pack is maximized, and a structural rigidity of the battery pack is sufficiently ensured, thereby maximizing the range of the vehicle and ensuring the rigidity of the battery pack and the crash performance of the vehicle excellently.

According to an embodiment of the disclosure, a battery pack for a vehicle includes a frontward wall and a rearward wall, lateral side walls connecting opposite ends of the frontward and rearward walls to form an accommodating space for accommodating battery modules, a longitudinal member including both ends supported on the frontward and rearward walls while crossing the accommodating space, a transverse member including both ends supported on the lateral side walls while intersecting the longitudinal member across the accommodating space, and a reinforcing bracket provided at an intersection between the longitudinal member and the transverse member to increase a coupling rigidity between the longitudinal member and the transverse member.

The battery pack may further include a module mounting bar provided inside the side wall, wherein the battery modules accommodated in the accommodating space are structured to have one of two sides perpendicular to an overlapping direction of battery cells and secured to the module mounting bar and the other of the two sides secured to the longitudinal member.

The reinforcing bracket may include two legs that are connected to each other to form an L-shape while being in surface-contact with the longitudinal member or the transverse member.

The two legs of the reinforcing bracket each may be formed to have a plate shape, and the longitudinal member and the transverse member may be formed with bracket mounting grooves in which the legs having the plate shape are inserted not to protrude from above the surfaces of the longitudinal member and the transverse member.

The bracket mounting grooves of the longitudinal member and the transverse member may be formed being biased downward on the lateral sides of the longitudinal member and the transverse member.

Each of the longitudinal member and the transverse member may have a cross-sectional shape in which a plurality of closed cross-sections are vertically connected in layers and may include vertical walls on both sides thereof, in which both vertical walls forming the lowermost closed cross-section are structured to form the closed cross-section on an inside and form bracket mounting grooves on an outside.

The longitudinal member may include a module mounting nut on an upper side thereof to which a module mounting bolt for securing the battery module is fastened.

The reinforcing brackets may be respectively provided at four corners where a lateral side of the longitudinal member and a lateral side of the transverse member meet each other.

The leg of the reinforcing bracket may be fastened by a leg coupling bolt that couples with the leg of the reinforcing bracket provided on an opposite side while penetrating the longitudinal member or the transverse member.

The legs of the two reinforcing brackets, which are fastened by the leg coupling bolt with the longitudinal member or the transverse member therebetween, may include a head coupling groove allowing a bolt head of the leg coupling bolt to be sunken from the surface of the leg and a female screw allowing the leg coupling bolt to be fastened thereto as being sunken from the surface of the leg, in which the head coupling groove and the female screw correspond to each other.

The leg of the reinforcing bracket may include a flat surface on one side to be in close contact with the bracket mounting groove of the longitudinal member or the transverse member and a reinforcing grid formed by a plurality of intersecting ribs on the opposite side, and the reinforcing grid may be formed on the same plane as the lateral side of the longitudinal member or the transverse member.

The battery pack may further include a cooling block provided below the longitudinal member and the transverse member, supporting a bottom of the battery module, and including a plurality of closed cross-sections.

Only one longitudinal member may be provided in the accommodating space, and only one transverse member may be provided in the accommodating space.

The battery pack may further include a pack mounting bolt fastened at the intersection between the longitudinal member and the transverse member to secure the battery pack to a vehicle body while penetrating the battery pack vertically.

The battery pack may further include a through mounting bush provided at the intersection between the longitudinal member and the transverse member while penetrating the battery pack from a bottom of the battery pack to a top of the transverse member to form a space through which the pack mounting bolt passes, a securing mounting bush provided to be inserted from the top of the transverse member and to surround an outer surface of the through mounting bush, and a bush bolt provided with an internal space through which the pack mounting bolt passes and coupled to a top of the through mounting bush with a flange thereof pressing the securing mounting bush against the transverse member.

According to embodiments of the disclosure, the number of battery cells accommodated in the battery pack is maximized, and the structural rigidity of the battery pack is sufficiently ensured, thereby maximizing the range of the vehicle and ensuring the rigidity of the battery pack and the crash performance of the vehicle excellently.

### BRIEF DESCRIPTION OF THE DRAWINGS

FIG. 1 is a view depicting a battery pack for a vehicle according to embodiments of the disclosure.

FIG. 2 is a view depicting the battery pack of FIG. 1 from which an upper cover is removed.

FIG. 3 is a perspective view of the battery pack cut along line III-III of FIG. 2.

FIG. 4 is a view depicting the battery pack of FIG. 2 from which battery modules are removed.

FIG. 5 is a view depicting the battery pack of FIG. 4 from which a longitudinal member is removed.

FIG. 6 is a view depicting the battery pack of FIG. 4 from which a transverse member is removed.

FIG. 7 is a view depicting the battery pack of FIG. 4 from which both the longitudinal member and the transverse member are removed.

FIG. 8 is a cross-sectional view taken along line VIII-VIII of FIG. 1.

FIG. 9 is a cross-sectional view taken along line IX-IX of FIG. 1.

FIG. 10 is a cross-sectional view taken along line X-X of FIG. 1.

### DETAILED DESCRIPTION OF ILLUSTRATIVE EMBODIMENTS

Hereinafter, embodiments of the disclosure will be described in detail with reference to the accompanying drawings, in which the same or similar elements are denoted by the same reference numerals even though they are depicted in different drawings and redundant descriptions thereof will be avoided.

Suffixes “module” and “unit” put after elements in the following description are given only in consideration of ease of description and do not have meanings or functions discriminated from each other.

In terms of describing the embodiments of the disclosure, detailed descriptions of the related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents, and substitutions within the scope and spirit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

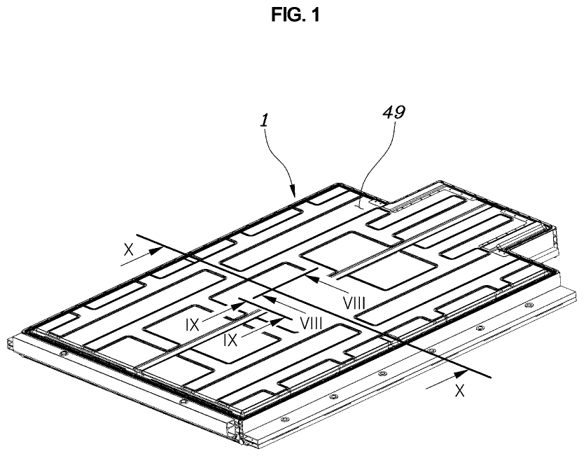

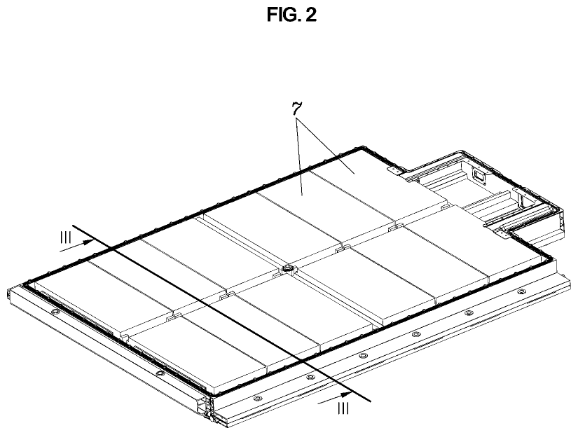

FIG. 1 shows a battery pack 1 according to embodiments of the disclosure, in which battery modules 7 accommodated in an accommodating space S (to be described later) are seen as shown in FIG. 2 by removing the upper cover 49 from the top of the battery pack 1.

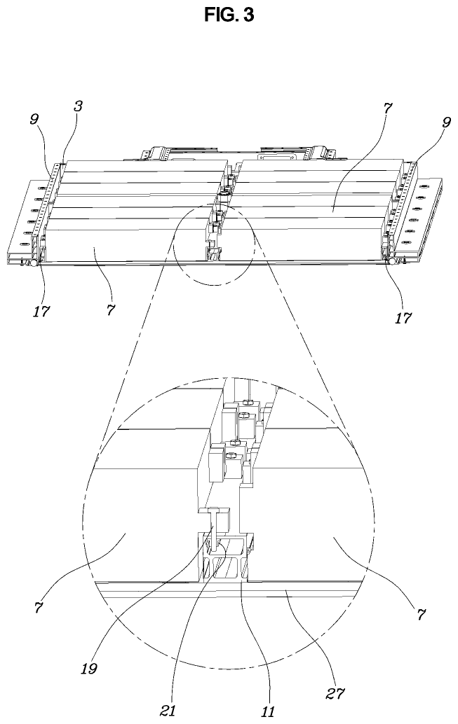

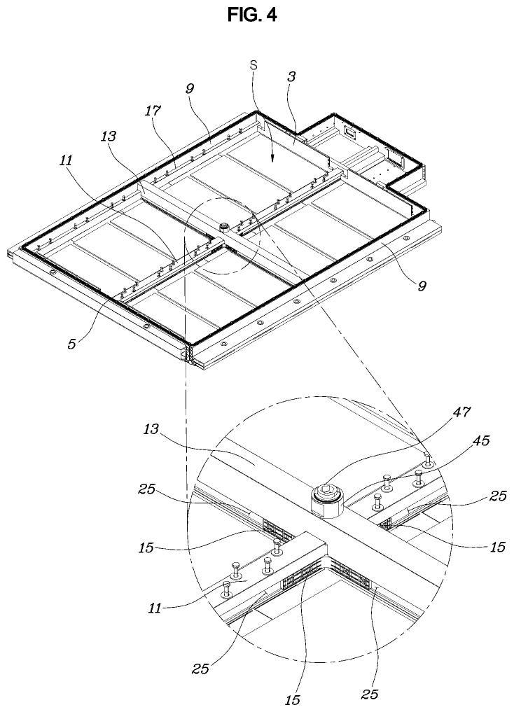

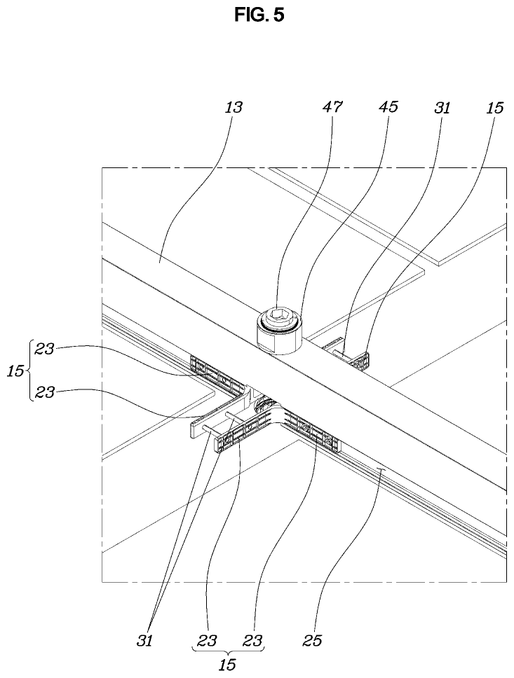

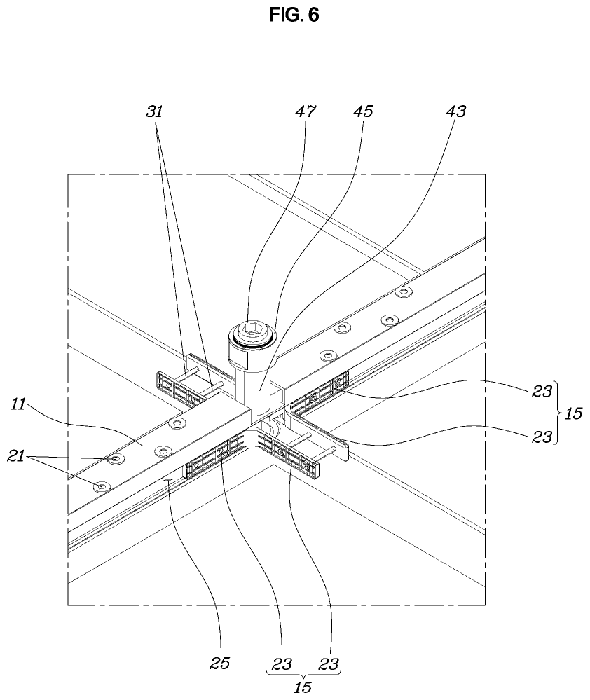

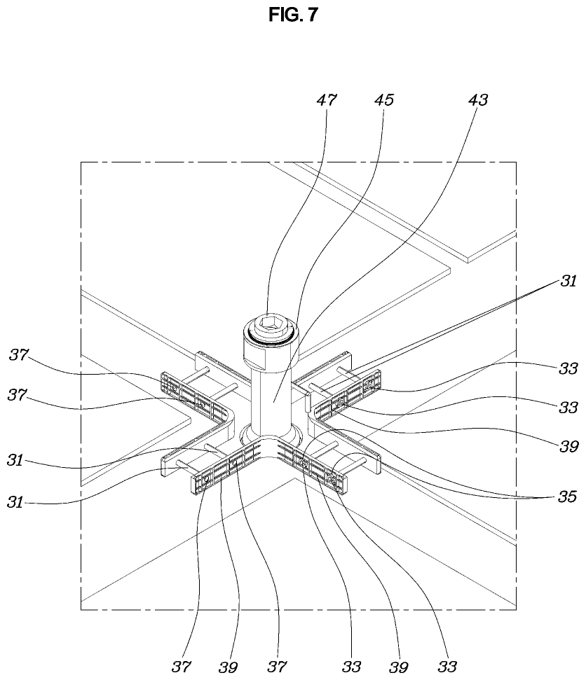

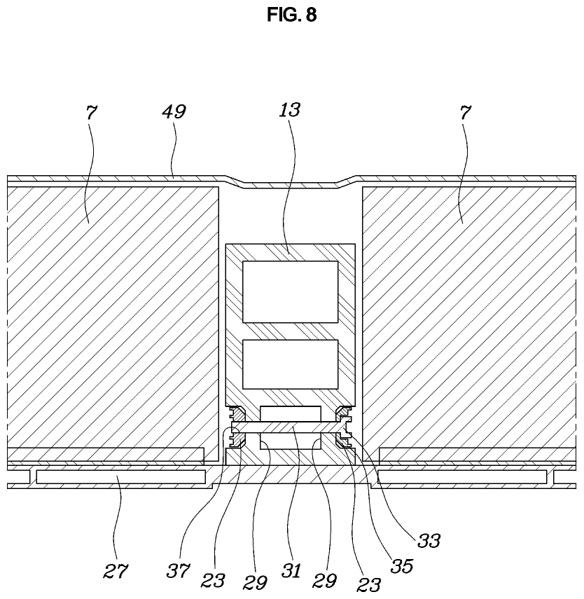

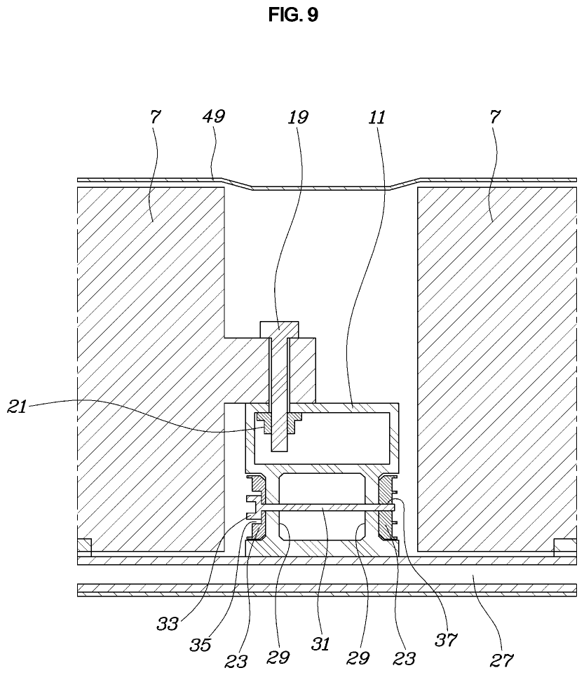

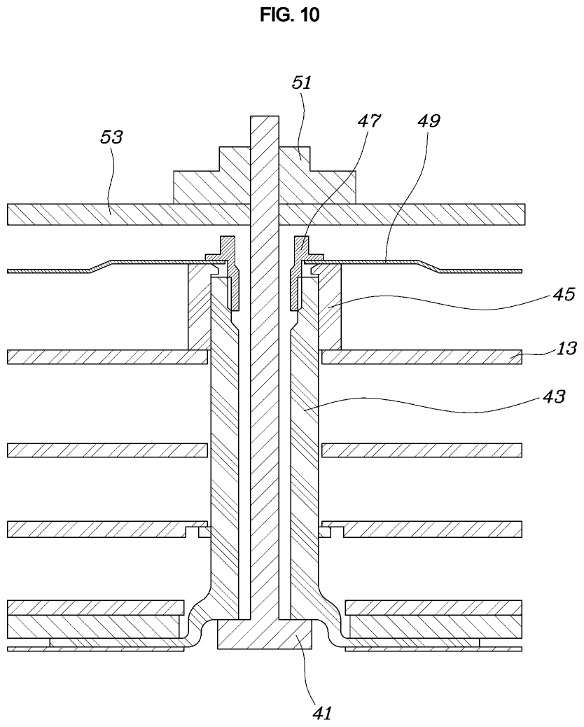

Referring to FIGS. 1 to 10, the battery pack 1 for a vehicle according to embodiments of the disclosure includes a frontward wall 3 and a rearward wall 5, lateral side walls 9 connecting the opposite ends of the frontward and rearward walls 3 and 5 to form an accommodating space S to accommodate the battery modules 7, a longitudinal member 11 having both ends supported on the frontward wall 3 and the rearward wall 5 while crossing the accommodating space S, a transverse member 13 having both ends supported on the lateral side walls 9 while intersecting the longitudinal member 11 across the accommodating space S, and a reinforcing bracket 15 installed at an intersection between the longitudinal member 11 and the transverse member 13 to increase a coupling rigidity between the longitudinal member 11 and the transverse member 13.

Here, only one longitudinal member 11 is provided in the accommodating space S, and only one transverse member 13 is provided in the accommodating space S.

Therefore, the accommodating space S formed by the frontward wall 3, the rearward wall 5, and the lateral side walls 9 is provided with only one longitudinal member 11 and only one transverse member 13 to accommodate more battery cells or battery modules 7, thereby having an effect on increasing the range of the vehicle.

Further, the longitudinal member 11 and the transverse member 13 have a structure where a plurality of closed cross-sections (to be described later) are connected and form a strong coupling structure with the reinforcing bracket 15 to secure the rigidity of the battery pack 1, so that sufficient rigidity required in the battery pack 1 can be secured even though only one longitudinal member 11 and one transverse member 13 are provided, thereby ultimately ensuring appropriate crash performance of the vehicle.

A module mounting bar 17 is provided inside the side wall 9, and the battery module 7 accommodated in the accommodating space S is structured to have one of two sides perpendicular to an overlapping direction of the battery cells and secured to the module mounting bar 17 and the other of the two sides secured to the longitudinal member 11.

Therefore, the battery cells of the battery module 7 may form a surface pressure due to support provided by the transverse member 13, the frontward wall 3, and the rearward wall 5.

For reference, the longitudinal member 11 is provided with a module mounting nut 21 on an upper side thereof to which a module mounting bolt 19 for securing the battery module 7 is fastened.

The reinforcing bracket 15 includes two legs that are connected to each other to form an L-shape while being in surface-contact with the longitudinal member 11 or the transverse member 13.

Here, the two legs 23 of the reinforcing bracket 15 are each formed to have a plate shape, and the longitudinal member 11 and the transverse member 13 are formed with bracket mounting grooves 25 in which the legs 23 having the plate shape are inserted not to protrude from above the surfaces of the longitudinal member 11 and the transverse member 13.

Therefore, the reinforcing bracket 15 is inserted in the longitudinal member 11 or the transverse member 13 and does not invade a space in which the battery modules 7 are accommodated, thereby allowing more battery cells to be mounted, and further allowing the transverse member 13 to provide more even surface pressure to the battery cells.

The bracket mounting grooves 25 of the longitudinal member 11 and the transverse member 13 are formed being biased downward on the lateral sides of the longitudinal member 11 and the transverse member 13.

Therefore, the reinforcing bracket 15 is provided in a lower portion on the lateral sides of the longitudinal member 11 and the transverse member 13.

Further, a cooling block 27 having a plurality of closed cross-sections is provided below the longitudinal member 11 and the transverse member 13 and supports the bottom of the battery module 7.

Here, the cooling block 27 may include an extruded panel or the like integrally formed with a plurality of coolant channels, so that the plurality of coolant channels can form the plurality of closed cross-sections.

Therefore, portions of the longitudinal member 11 and the transverse member 13, in which the reinforcing brackets 15 are placed, serve as an integrally connected cross-sectional structure along with the cooling block 27 structured to secure the rigidity by the plurality of closed cross-sections, thereby having an effect on substantially increasing cross-sectional moments of the longitudinal member 11 and the transverse member 13 and significantly contributing to increasing the rigidity of the battery pack ultimately.

Each of the longitudinal member 11 and the transverse member 13 has a cross-sectional shape in which the plurality of closed cross-sections are vertically connected in layers and includes vertical walls 29 on both sides thereof, in which both vertical walls 29 forming the lowermost closed cross-section are structured to form the closed cross-section on the inside and form the bracket mounting grooves 25 on the outside.

In practice, each of the longitudinal member 11 and the transverse member 13 may be achieved by an extruded member having a structure in which the closed cross-sections are connected up and down forming the bracket mounting grooves 25 on both sides.

Therefore, as described above, the longitudinal member 11 and the transverse member 13 reduce the weight of the battery pack 1 while providing rigidity superior to those of conventional members having a simple single cross-section structure.

The reinforcing brackets 15 are respectively installed at four corners where the lateral sides of the longitudinal member 11 and the lateral sides of the transverse member 13 meet each other, thereby maximizing the coupling rigidity of the intersection between the longitudinal member 11 and the transverse member 13.

The leg 23 of the reinforcing bracket 15 is fastened by a leg coupling bolt 31 that couples with the leg 23 of the reinforcing bracket 15 installed on the opposite side while penetrating the longitudinal member 11 or the transverse member 13.

Here, the legs 23 of the two reinforcing brackets 15, which are fastened by the leg coupling bolt 31 with the longitudinal member 11 or the transverse member 13 therebetween, include a head coupling groove 35 allowing a bolt head 33 of the leg coupling bolt 31 to be sunken from the surface of the leg 23 and a female screw 37 allowing the leg coupling bolt 31 to be fastened thereto as being sunken from the surface of the leg 23, in which the head coupling groove 35 and the female screw 37 correspond to each other.

Therefore, the reinforcing bracket 15 and the leg coupling bolt 31 do not protrude from above the surface of the longitudinal member 11 or the transverse member 13 even when the leg coupling bolt 31 is fastened to the reinforcing bracket 15.

Meanwhile, the leg 23 of the reinforcing bracket 15 includes a flat surface on one side to be in close contact with the bracket mounting groove 25 of the longitudinal member 11 or the transverse member 13 and a reinforcing grid 39 formed by a plurality of intersecting ribs on the opposite side, and the reinforcing grid 39 is formed on the same plane as the lateral side of the longitudinal member 11 or the transverse member 13.

Therefore, the reinforcing bracket 15 does not protrude from above the lateral side of the longitudinal member 11 or the transverse member 13 while the rigidity of the reinforcing bracket 15 itself is further enhanced by the reinforcing grid 39, thereby maintaining a structure advantageous to mount more battery cells and forming the surface pressure of the battery cells.

A pack mounting bolt 41 for securing the battery pack 1 to a vehicle body is fastened at the intersection between the longitudinal member 11 and the transverse member 13 while penetrating the battery pack 1 vertically.

To form a space through which the pack mounting bolt 41 passes, a through mounting bush 43 is provided at the intersection between the longitudinal member 11 and the transverse member 13 while penetrating the battery pack 1 from the bottom of the battery pack 1 to the top of the transverse member 13.

A securing mounting bush 45 is provided to be inserted from the top of the transverse member 13 and surround the outer surface of the through mounting bush 43, and a bush bolt 47 is provided to have an internal space through which the pack mounting bolt 41 passes and to be coupled to the top of the through mounting bush 43 so that its flange can press the securing mounting bush 45 against the transverse member 13.

Therefore, the pack mounting bolt 41 is fastened to a vehicle body nut 51 provided in a vehicle body 53 while passing through the through mounting bush 43, the securing mounting bush 45, and the bush bolt 47, so that the battery pack 1 can be firmly supported on the bottom of the vehicle body.

Although specific embodiments of the disclosure have been illustrated and described as above, various modifications and changes can be made by a person having ordinary knowledge in the art without departing from the scope of technical ideas defined by the appended claims.

What is claimed is:

1. A battery pack for a vehicle, the battery pack comprising:
a frontward wall;
a rearward wall;
lateral side walls connecting opposite ends of the frontward and rearward walls to define an accommodating space for accommodating battery modules;
a longitudinal member having first and second ends supported on the frontward and rearward walls, respectively, while crossing the accommodating space;
a transverse member having first and second ends supported on the lateral side walls, respectively, while intersecting the longitudinal member across the accommodating space; and
a reinforcing bracket disposed at an intersection between the longitudinal member and the transverse member, the reinforcing bracket increasing a coupling rigidity between the longitudinal member and the transverse member so that the coupling rigidity with the reinforcing bracket is greater than the coupling rigidity of the same structure without any reinforcing bracket.

2. The battery pack of claim 1, further comprising module mounting bars disposed inside each of the lateral side walls, respectively, wherein the battery modules accommodated in the accommodating space are structured such that a first side of two sides perpendicular to an overlapping direction of battery cells is secured to the module mounting bars and a second side of the two sides is secured to the longitudinal member.

3. The battery pack of claim 2, wherein the reinforcing bracket comprises two legs that are connected to each other to define an L-shape while being in surface-contact with the longitudinal member or the transverse member.

4. The battery pack of claim 3, wherein:
each of the two legs of the reinforcing bracket has a plate shape; and
the longitudinal member and the transverse member comprise bracket mounting grooves in which the legs having the plate shape are inserted not to protrude from above surfaces of the longitudinal member and the transverse member.

5. The battery pack of claim 4, wherein the bracket mounting grooves of the longitudinal member and the transverse member are biased downward on lateral sides of the longitudinal member and the transverse member.

6. The battery pack of claim 5, wherein:
each of the longitudinal member and the transverse member has a cross-sectional shape in which a plurality of closed cross-sections are vertically connected in layers; and
each of the longitudinal member and the transverse member comprises vertical walls on both sides thereof, in which both vertical walls forming a lowermost closed cross-section are structured to define the closed cross-section on an inside and to define the bracket mounting grooves on an outside.

7. The battery pack of claim 6, wherein the longitudinal member comprises a module mounting nut on an upper side thereof, and wherein a module mounting bolt for securing the battery module is fastened to the module mounting nut.

8. The battery pack of claim 6, wherein the reinforcing bracket is provided in plural, and wherein the reinforcing brackets are respectively provided at four corners where a lateral side of the longitudinal member and a lateral side of the transverse member meet each other.

9. The battery pack of claim 8, wherein each of the legs of the reinforcing bracket is fastened by a leg coupling bolt that couples with the leg of the reinforcing bracket provided on an opposite side while penetrating the longitudinal member or the transverse member.

10. The battery pack of claim 9, wherein:
the legs of the two reinforcing brackets are fastened by the leg coupling bolts with the longitudinal member or the transverse member therebetween;
each of the legs comprises a head coupling groove allowing a bolt head of the leg coupling bolt to be sunken from a surface of the leg and a female screw allowing the leg coupling bolt to be fastened thereto as being sunken from the surface of the leg; and
the head coupling groove and the female screw correspond to each other.

11. The battery pack of claim 10, wherein:
each of the legs of the reinforcing bracket comprises a flat surface on a first side to be in close contact with the bracket mounting groove of the longitudinal member or the transverse member and a reinforcing grid defined by a plurality of intersecting ribs on a second side opposite the first side; and
the reinforcing grid is disposed on a same plane as the lateral side of the longitudinal member or the transverse member.

12. The battery pack of claim 6, further comprising a cooling block disposed below the longitudinal member and the transverse member and comprising a plurality of closed cross-sections, wherein the cooling block is configured to support a bottom of the battery module.

13. A battery pack for a vehicle, the battery pack comprising:
a frontward wall;
a rearward wall;
lateral side walls connecting opposite ends of the frontward and rearward walls to define an accommodating space for accommodating battery modules;
a longitudinal member having first and second ends supported on the frontward and rearward walls, respectively, while crossing the accommodating space, wherein only one longitudinal member is disposed in the accommodating space;
a transverse member having first and second ends supported on the lateral side walls, respectively, while intersecting the longitudinal member across the accommodating space, wherein only one transverse member is disposed in the accommodating space; and
a reinforcing bracket disposed at an intersection between the longitudinal member and the transverse member, the reinforcing bracket increasing a coupling rigidity between the longitudinal member and the transverse member so that the coupling rigidity with the reinforcing bracket is greater than the coupling rigidity of the same structure without any reinforcing bracket.

14. The battery pack of claim 13, further comprising a pack mounting bolt fastened at the intersection between the longitudinal member and the transverse member to secure the battery pack to a vehicle body while penetrating the battery pack vertically.

15. The battery pack of claim 14, further comprising:
a through mounting bush disposed at the intersection between the longitudinal member and the transverse member while penetrating the battery pack from a bottom of the battery pack to a top of the transverse member to define a space through which the pack mounting bolt passes;
a securing mounting bush disposed to be inserted from the top of the transverse member and to surround an outer surface of the through mounting bush; and
a bush bolt having an internal space through which the pack mounting bolt passes, the bush bolt being coupled to a top of the through mounting bush with a flange thereof pressing the securing mounting bush against the transverse member.

16. A method of manufacturing a battery pack for a vehicle, the method comprising:
connecting opposite ends of a frontward wall and a rearward wall with lateral side walls to define an accommodating space for accommodating battery modules;
attaching a longitudinal member across the accommodating space, wherein first and second ends of the longitudinal member are supported on the frontward and rearward walls, respectively;
attaching a transverse member to intersect the longitudinal member across the accommodating space, wherein first and second ends of the transverse member are supported on the lateral side walls, respectively; and
attaching a reinforcing bracket at an intersection between the longitudinal member and the transverse member thereby increasing a coupling rigidity between the longitudinal member and the transverse member.

17. The method of claim 16, further comprising attaching module mounting bars inside each of the lateral side walls, respectively, wherein the battery modules accommodated in the accommodating space are structured such that a first side of two sides perpendicular to an overlapping direction of battery cells is secured to the module mounting bars and a second side of the two sides is secured to the longitudinal member.

18. The method of claim 17, wherein the reinforcing bracket comprises two legs that are connected to each other to define an L-shape while being in surface-contact with the longitudinal member or the transverse member.

19. The method of claim 18, wherein:
each of the two legs of the reinforcing bracket has a plate shape;
the longitudinal member and the transverse member comprise bracket mounting grooves in which the legs having the plate shape are inserted not to protrude from above surfaces of the longitudinal member and the transverse member; and
the bracket mounting grooves of the longitudinal member and the transverse member are biased downward on lateral sides of the longitudinal member and the transverse member.

20. The method of claim 19, wherein:
each of the longitudinal member and the transverse member has a cross-sectional shape in which a plurality of closed cross-sections are vertically connected in layers; and
each of the longitudinal member and the transverse member comprises vertical walls on both sides thereof, in which both vertical walls forming a lowermost closed cross-section are structured to define the closed cross-section on an inside and to define the bracket mounting grooves on an outside.
